(19) United States
(12) Patent Application Publication
(10) Pub. No.: US 2008/0244665 A1
(43) Pub. Date: Oct. 2, 2008

(54) System and method of providing video content

(75) Inventors: Donald Bowen, Madison, NJ (US); Lusheng Ji, Randolph, NJ (US); David Britz, Rumson, NJ (US); Constance Coty, White House, NJ (US)

Correspondence Address: TOLER LAW GROUP, 8500 BLUFFSTONE COVE, SUITE A201, AUSTIN, TX, 78759, US

(73) Assignee: AT&T Knowledge Ventures, LP, Reno, NV (US)

(21) Appl. No.: 11/732,131

(22) Filed: Apr. 2, 2007

(51) Int. Cl. H04N 7/18

(52) U.S. Cl. 725/83

(57) ABSTRACT

A method of providing video content is disclosed that includes identifying a current user of a set-top box device, where a plurality of users that includes the current user is associated with the set-top box device. The method also includes identifying a first channel associated with the set-top box device, where the set-top box device is tuned to the first channel. Further, the method includes predicting that the current user will select at least one next channel based on historical data associated with the current user. The method also includes streaming video content of the at least one next channel to the set-top box device via a video distribution network while the set-top box device is tuned to the first channel.

### FIELD OF THE DISCLOSURE

The present disclosure is generally related to systems and methods of providing video content.

### BACKGROUND

Television viewing is part of daily life for many people. Certain networks that provide video content may experience limitations that lead to an undesirable television viewing experience. For example, viewers may experience channel change latency after switching channels, as video content of a new channel is sent to and buffered by a receiving device. Hence, there is a need for an improved system and method of providing video content.

### BRIEF DESCRIPTION OF THE DRAWINGS

FIG. 1 is a block diagram illustrating an embodiment of a system to provide video content;

FIG. 2 is a block diagram illustrating a second particular illustrative embodiment of a system to provide video content;

FIG. 3 is a flow diagram of a particular illustrative embodiment of a method of providing video content;

FIG. 4 is a flow diagram of a second particular illustrative embodiment of a method of providing video content;

FIG. 5 is a diagram of an arrangement of data in a system providing video content; and

FIG. 6 is a block diagram of an illustrative embodiment of a general computer system.

### DETAILED DESCRIPTION OF THE DRAWINGS

A system to provide video content is disclosed that includes a processor and a memory accessible to the processor. The memory includes a user identification module executable by the processor to identify a current user of a set-top box device, where a plurality of users that includes the current user is associated with the set-top box device. The memory also includes a user behavior module executable by the processor to identify a first channel associated with the set-top box device, where the set-top box device is tuned to the first channel. Further, the memory includes a prediction module executable by the processor to predict that the current user will select a next channel based on historical data associated with the current user. The memory also includes a video content module executable by the processor to instruct a video source to send video content of the next channel to the set-top box device via a video distribution network while the set-top box device is tuned to the first channel.

In another embodiment, a set-top box device is disclosed that includes a processor and a memory accessible to the processor. The memory includes a user identification module executable by the processor to identify a current user of a set-top box device, where a plurality of users that includes the current user is associated with the set-top box device. The memory also includes a channel prediction module executable by the processor to determine that the set-top box device is tuned to a first channel and to predict that the current user will select a next channel based on historical data associated with the current user. Further, the memory includes a video content request module executable by the processor to request video content of the next channel, where the set-top box device receives the video content of the next channel while the set-top box device is tuned to the first channel.

In another embodiment, a method of providing video content is disclosed that includes identifying a current user of a set-top box device, where a plurality of users that includes the current user is associated with the set-top box device. The method also includes identifying a first channel associated with the set-top box device, where the set-top box device is tuned to the first channel. Further, the method includes predicting that the current user will select at least one next channel based on historical data associated with the current user. The method also includes streaming video content of the at least one next channel to the set-top box device via a video distribution network while the set-top box device is tuned to the first channel.

In another embodiment, a method of providing video content is disclosed that includes identifying a first channel associated with a set-top-box device, where the set-top box device is tuned to the first channel. The method also includes determining a number of next channels to predict based at least partially on available resources of a video distribution network. Further, the method includes predicting, based on historical data associated with the set-top box device, that the set-top box device will be tuned to one of a plurality of next channels, where the plurality of next channels includes the determined number of next channels. The method also includes streaming video content of each of the plurality of next channels to the set-top box device while the set-top box device is tuned to the first channel.

In another embodiment, a computer-readable medium is disclosed that includes instructions to cause a processor to execute a method that includes identifying a first channel associated with a set-top box device, where the set-top box device is tuned to the first channel. The computer-readable medium also includes instructions to cause a processor to execute a method that includes determining a number of next channels to predict based at least partially on available resources of a video distribution network. Further, the computer-readable medium includes instructions to cause a processor to execute a method that includes predicting, based on historical data associated with the set-top box device, that the set-top box device will be tuned to one of a plurality of next channels, where the plurality of next channels includes the determined number of next channels. The computer-readable medium also includes instructions to cause a processor to execute a method that includes streaming video content of each of the plurality of next channels to the set-top box device while the set-top box device is tuned to the first channel.

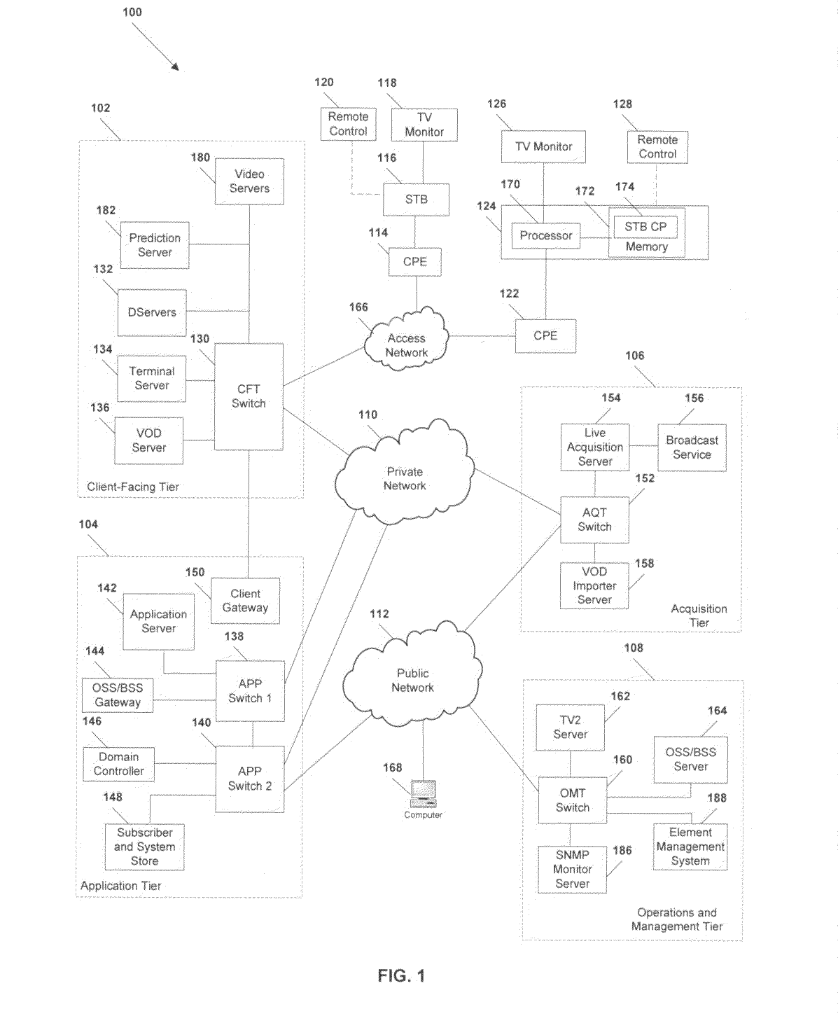

Referring to FIG. 1, an illustrative embodiment of an Internet Protocol Television (IPTV) system that may be used to provide a set-top box application is illustrated and is generally designated 100. As shown, the system 100 can include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 can be coupled to the private network 110. Further, the application tier 104 can be coupled to the private network 110 and to the public network 112. The acquisition tier 106 can also be coupled to the private network 110 and to the public network 112. Additionally, the operations and management tier 108 can be coupled to the public network 112.

As illustrated in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104, including, but not limited to a client gateway 150, can communicate directly with the client-facing tier 102.

The client-facing tier 102 can communicate with user equipment via an access network 166, such as an Internet Protocol Television (IPTV) access network. In an illustrative embodiment, customer premises equipment (CPE) 114, 122 can be coupled to a local switch, router, or other device of the access network 166. The client-facing tier 102 can communicate with a first representative set-top box device 116 via the first CPE 114 and with a second representative set-top box device 124 via the second CPE 122. In a particular embodiment, the first representative set-top box device 116 and the first CPE 114 can be located at a first customer premise, and the second representative set-top box device 124 and the second CPE 122 can be located at a second customer premise. In another particular embodiment, the first representative set-top box device 116 and the second representative set-top box device 124 can be located at a single customer premise, both coupled to one of the CPE 114, 122. The CPE 114, 122 can include routers, local area network devices, modems, such as digital subscriber line (DSL) modems, any other suitable devices for facilitating communication between a set-top box device and the access network 166, or any combination thereof.

In an exemplary embodiment, the client-facing tier 102 can be coupled to the CPE 114, 122 via fiber optic cables. In another exemplary embodiment, the CPE 114, 122 can be digital subscriber line (DSL) modems that are coupled to one or more network nodes via twisted pairs, and the client-facing tier 102 can be coupled to the network nodes via fiber-optic cables. Each set-top box device 116, 124 can process data received via the access network 166, via an IPTV software platform, such as Microsoft® TV IPTV Edition.

The first set-top box device 116 can be coupled to a first external display device, such as a first television monitor 118, and the second set-top box device 124 can be coupled to a second external display device, such as a second television monitor 126. Moreover, the first set-top box device 116 can communicate with a first remote control 120, and the second set-top box device 124 can communicate with a second remote control 128. The set-top box devices 116, 124 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 116, 124 can receive data, video, or any combination thereof, from the client-facing tier 102 via the access network 166 and render or display the data, video, or any combination thereof, at the display device 118, 126 to which it is coupled. In an illustrative embodiment, the set-top box devices 116, 124 can include tuners that receive and decode television programming signals or packet streams for transmission to the display devices 118, 126. Further, the set-top box devices 116, 124 can include a STB processor 170 and a STB memory device 172 that is accessible to the STB processor 170. In one embodiment, a computer program, such as the STB computer program 174, can be embedded within the STB memory device 172.

In an illustrative embodiment, the client-facing tier 102 can include a client-facing tier (CFT) switch 130 that manages communication between the client-facing tier 102 and the access network 166 and between the client-facing tier 102 and the private network 110. As illustrated, the CFT switch 130 is coupled to one or more data servers, such as D-servers 132, that store, format, encode, replicate, or otherwise manipulate or prepare video content for communication from the client-facing tier 102 to the set-top box devices 116, 124. The CFT switch 130 can also be coupled to a terminal server 134 that provides terminal devices with a point of connection to the IPTV system 100 via the client-facing tier 102. In a particular embodiment, the CFT switch 130 can be coupled to a video-on-demand (VOD) server 136 that stores or provides VOD content imported by the IPTV system 100. Further, the CFT switch 130 is coupled to one or more video servers 180 that receive video content and transmit the content to the set-top boxes 116, 124 via the access network 166. In addition, the CFT switch can be coupled to a prediction server 182 that predicts a plurality of channels that users of set-top box devices 116, 124 may select.

In an illustrative embodiment, the client-facing tier 102 can communicate with a large number of set-top boxes, such as the representative set-top boxes 116, 124, over a wide geographic area, such as a metropolitan area, a viewing area, a statewide area, a regional area, a nationwide area or any other suitable geographic area, market area, or subscriber or customer group that can be supported by networking the client-facing tier 102 to numerous set-top box devices. In a particular embodiment, the CFT switch 130, or any portion thereof, can include a multicast router or switch that communicates with multiple set-top box devices via a multicast-enabled network.

As illustrated in FIG. 1, the application tier 104 can communicate with both the private network 110 and the public network 112. The application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. In a particular embodiment, the application server 142 can provide applications to the set-top box devices 116, 124 via the access network 166, which enable the set-top box devices 116, 124 to provide functions, such as interactive program guides, video gaming, display, messaging, processing of VOD material and other IPTV content, etc. In an illustrative embodiment, the application server 142 can provide location information to the set-top box devices 116, 124. In a particular embodiment, the OSS/BSS gateway 144 includes operation systems and support (OSS) data, as well as billing systems and support (BSS) data. In one embodiment, the OSS/BSS gateway 144 can provide or restrict access to an OSS/BSS server 164 that stores operations and billing systems data.

The second APP switch 140 can be coupled to a domain controller 146 that provides Internet access, for example, to users at their computers 168 via the public network 112. For example, the domain controller 146 can provide remote Internet access to IPTV account information, e-mail, personalized Internet services, or other online services via the public network 112. In addition, the second APP switch 140 can be coupled to a subscriber and system store 148 that includes account information, such as account information that is associated with users who access the IPTV system 100 via the private network 110 or the public network 112. In an illustrative embodiment, the subscriber and system store 148 can store subscriber or customer data and create subscriber or customer profiles that are associated with IP addresses, stock-keeping unit (SKU) numbers, other identifiers, or any combination thereof, of corresponding set-top box devices 116, 124. In another illustrative embodiment, the subscriber and system store can store data associated with capabilities of set-top box devices associated with particular customers.

In a particular embodiment, the application tier 104 can include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto. In an illustrative embodiment, the set-top box devices 116, 124 can access the IPTV system 100 via the access network 166, using information received from the client gateway 150. User devices can access the client gateway 150 via the access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the access network 166.

For example, when the first representative set-top box device 116 accesses the client-facing tier 102 via the access network 166, the client gateway 150 can verify subscriber information by communicating with the subscriber and system store 148 via the private network 110. Further, the client gateway 150 can verify billing information and status by communicating with the OSS/BSS gateway 144 via the private network 110. In one embodiment, the OSS/BSS gateway 144 can transmit a query via the public network 112 to the OSS/BSS server 164. After the client gateway 150 confirms subscriber and/or billing information, the client gateway 150 can allow the set-top box device 116 to access IPTV content and VOD content at the client-facing tier 102. If the client gateway 150 cannot verify subscriber information for the set-top box device 116, e.g., because it is connected to an unauthorized twisted pair, the client gateway 150 can block transmissions to and from the set-top box device 116 beyond the access network 166.

As indicated in FIG. 1, the acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives or acquires television content, movie content, advertisement content, other video content, or any combination thereof, from a broadcast service 156, such as a satellite acquisition system or satellite head-end office. In a particular embodiment, the live acquisition server 154 can transmit content to the AQT switch 152, and the AQT switch 152 can transmit the content to the CFT switch 130 via the private network 110.

In an illustrative embodiment, content can be transmitted to the D-servers 132, where it can be encoded, formatted, stored, replicated, or otherwise manipulated and prepared for communication from the video server(s) 180 to the set-top box devices 116, 124. The CFT switch 130 can receive content from the video server(s) 180 and communicate the content to the CPE 114, 122 via the access network 166. The set-top box devices 116, 124 can receive the content via the CPE 114, 122, and can transmit the content to the television monitors 118, 126. In an illustrative embodiment, video or audio portions of the content can be streamed to the set-top box devices 116, 124.

Further, the AQT switch 152 can be coupled to a video-on-demand importer server 158 that receives and stores television or movie content received at the acquisition tier 106 and communicates the stored content to the VOD server 136 at the client-facing tier 102 via the private network 110. Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When users issue requests for VOD content via the set-top box devices 116, 124, the requests can be transmitted over the access network 166 to the VOD server 136, via the CFT switch 130. Upon receiving such requests, the VOD server 136 can retrieve the requested VOD content and transmit the content to the set-top box devices 116,124 across the access network 166, via the CFT switch 130. The set-top box devices 116, 124 can transmit the VOD content to the television monitors 118, 126. In an illustrative embodiment, video or audio portions of VOD content can be streamed to the set-top box devices 116, 124.

FIG. 1 further illustrates that the operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to an OSS/BSS server 164 and to a simple network management protocol (SNMP) monitor server 186 that monitors network devices within or coupled to the IPTV system 100. In a particular embodiment, the OMT switch 160 can communicate with the AQT switch 152 via the public network 112. In a particular embodiment, the OMT switch 160 can be coupled to one or more element management systems 188 that collect performance data from network elements of the IPTV system 100.

In an illustrative embodiment, the live acquisition server 154 can transmit content to the AQT switch 152, and the AQT switch 152, in turn, can transmit the content to the OMT switch 160 via the public network 112. In this embodiment, the OMT switch 160 can transmit the content to the TV2 server 162 for display to users accessing the user interface at the TV2 server 162. For example, a user can access the TV2 server 162 using a personal computer 168 coupled to the public network 112.

In a particular illustrative embodiment, a user may engage a set-top box device, such as the second representative set-top box device 124, in a television viewing session. For example, the user can power on the set-top box device 124, and the set-top box device 124 may send a request to the video server(s) 180 for video content related to the last channel selection made via the set-top box device 124 before ending the previous television viewing session. Alternatively, the set-top box device 124 may send a request to the video server(s) 180 for video content related to a first channel selection made via set-top box device 124 after the set-top box device 124 has been activated for the current television viewing session. The current user associated with the set-top box device 124 may select the first channel using the remote control 128. Once the set-top box device 124 is tuned to the first channel selected by the current user, the current user may view video content related to the first channel via the TV monitor 126.

In a particular embodiment, the current user can be identified when the user initiates the television viewing session. For instance, the current user may be one of a plurality of users associated with the set-top box device 124. In an illustrative embodiment, the current user may be identified according to a user identification, such as a user name, an authentication token such as a password, or any combination thereof. In a further illustrative embodiment, the current user may be identified according to the remote control used to make inputs to a set-top box device, such as the remote control 128. For example, the set-top box device 124 may recognize that the remote control 128 is uniquely associated with the current user. In another illustrative embodiment, the current user may be identified based on channel selections during the television viewing session. For example, historical channel selection data for each user associated with the set-top box device 124 may be compared with channel selections during the television viewing session to determine the identity of the user.

In a particular embodiment, the prediction server 182 identifies a first channel to which the set-top box device 124 is tuned during the television viewing session. In an illustrative embodiment, the first channel may be identified at the prediction server 182 according to data sent from the set-top box device 124 to prediction server 182 indicating the channel selection made at the set-top box device 124. In an alternative illustrative, non-limiting embodiment, the first channel may be identified based on data received by the prediction server 182 from the video server(s) 180 indicating the channel associated with the video content that is currently sending to the set-top box device 124.

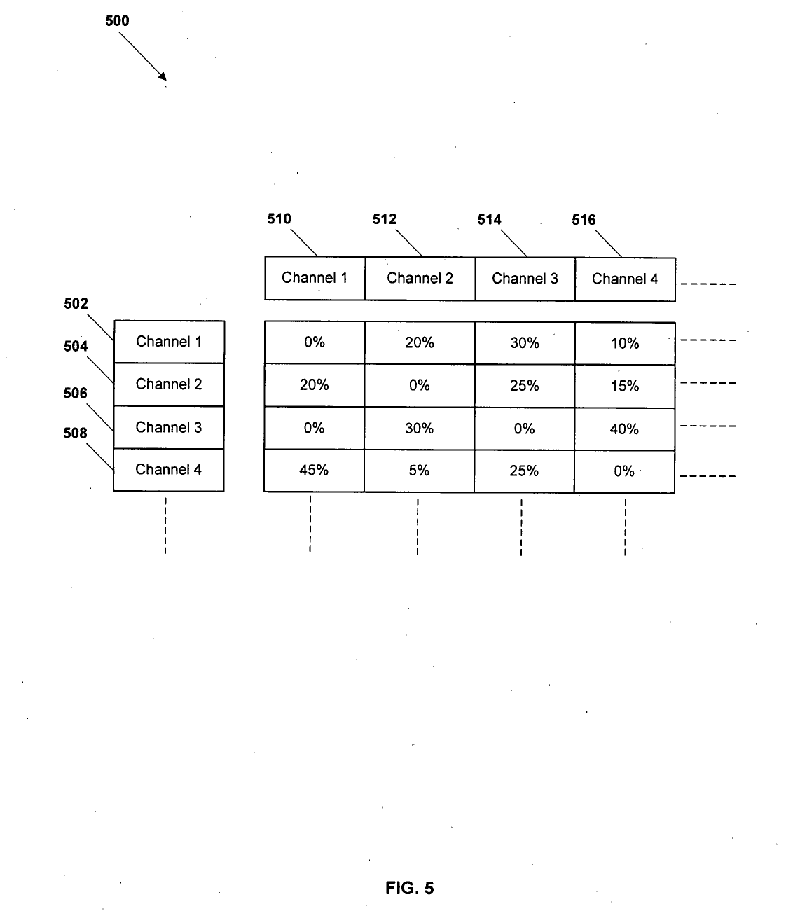

In a particular embodiment, the prediction server 182 predicts a plurality of next channels to which the set-top box device 124 may be tuned. In an illustrative embodiment, the next channels are predicted based on historical data associated with the set-top box device 124 and stored at the prediction server 182, the subscriber and system store 148, another server of the IPTV system 100, or any combination thereof. In one example, the historical data may include channel selection data corresponding to each of the users associated with the set-top box device 124, a favorite channel list associated with at least one user of the set-top box device, demographic data associated with at least one user of the set-top box device, or any combination thereof. Further, the channel selection data may be arranged according to a time of day when a particular channel is selected via the set-top box device 124. In an illustrative, non-limiting embodiment, the historical data may include one or more weighting factors applied to channel selections made within a pre-defined time period by the users of the set-top box device 124. For example, more recent channel selections or channel selection patterns can be weighted more heavily than less recent channel selections or channel selection patterns, such that predicted channels reflect changes in viewing habits of the current user over time. In a further illustrative, non-limiting embodiment, the historical data may include probability data, such as the probability data illustrated in FIG. 5, indicating the probability that a particular user of set-top box device 124 may switch from one particular channel to a next channel.

In a particular embodiment, the video content related to at least one of the plurality of predicted next channels is streamed to the set-top box device 124, while the set-top box device 124 is tuned to the first channel. In a particular embodiment, the available resources of a video distribution network, such as a network including the client-facing tier 102 and the access network 166, can be evaluated to determine the number of predicted next channels that may be streamed to the set-top box device 124. For example, the available resources of the video distribution network may support the streaming of video content to the set-top box device 124 related to the current channel tuned at the set-top box device 124, as well as video content related to two other channels available via the video distribution network.

The number of the predicted next channels whose video content is streamed to the set-top box device 124 may depend on the available resources of the access network 166 or other resources of the IPTV system 100. In an illustrative embodiment, the prediction server evaluates the available resources of the video distribution network based on performance data received from the one or more element management systems 188. The performance data may relate to the operation of elements in the video distribution network, such as a video-head end office, a central office, customer premises equipment, such as the CPE 122, and a set-top box device, such as the set-top box device 124. In an illustrative, non-limiting embodiment, the performance data from the one or more element management systems 188 may be sent to the client gateway 150 via the public network 112 and then forwarded to the prediction server 182 by the CFT switch 130.

In an illustrative embodiment, the available resources of the video distribution network may include a bandwidth of at least a portion of a communication path between a video content source, such as the video server(s) 180 or the VOD server 136, and the set-top box device 124. In another illustrative embodiment, the available resources of the video distribution network may include memory usage at the set-top box device 124. In a further illustrative embodiment, the available resources of the video distribution network may include data load at customer premises equipment, such as the CPE 122, coupled to the set-top box device 124.

In an illustrative, non-limiting embodiment, the number of predicted next channels streamed to the set-top box device 124 may also be based on a video content resolution associated with each of the predicted next channels. For example, if standard definition video content is associated with three predicted next channels, video content of all three channels may be streamed to the set-top box device 124. Whereas, if one of the channels is a high-definition channel, video content associated with only that predicted next channel may be streamed to the set-top box device 124 while the set-top box device 124 is tuned to a first channel.

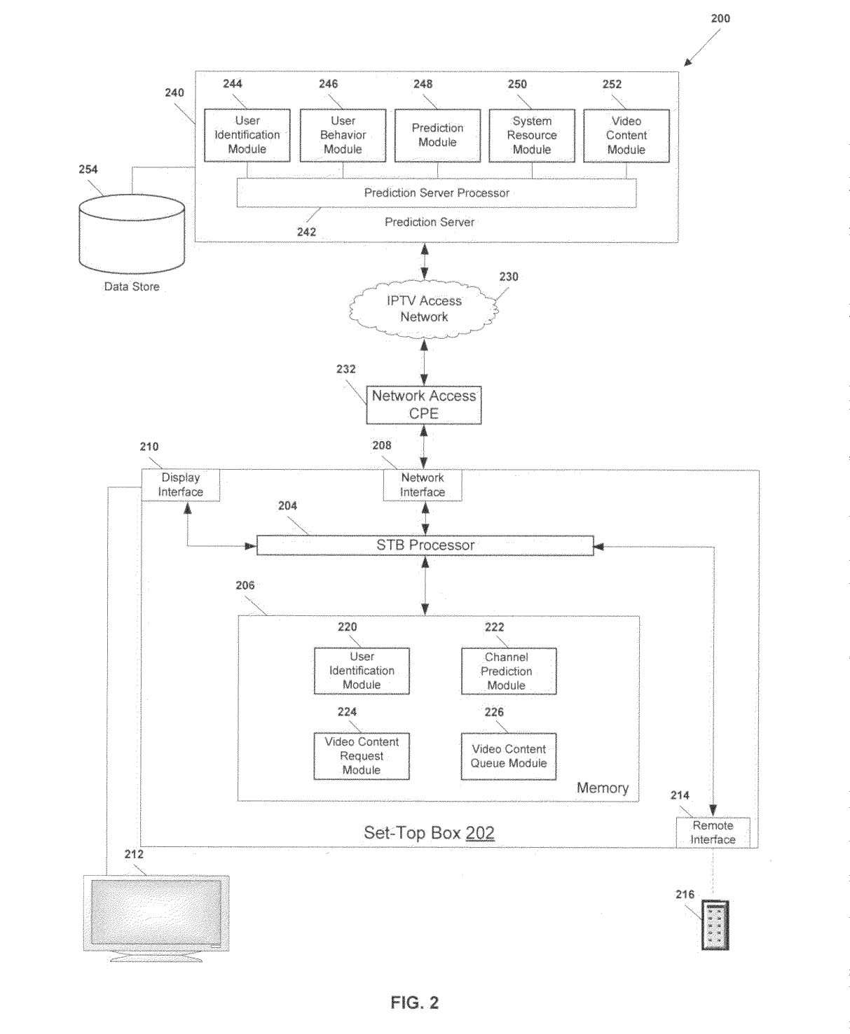

FIG. 2 is a block diagram of a second particular illustrative embodiment of a system 200 to provide video content. The system 200 includes a set-top box device 202 that communicates with a prediction server 240 of an Internet Protocol Television (EPTV) via an IPTV access network 230. The set-top box device 202 includes a STB processor 204 and a memory 206 accessible to the STB processor 204. The STB processor can communicate video content to a display device 212 via a display interface 210. In addition, the STB processor 204 can receive commands from a remote control device 216 via a remote interface 214.

In a particular embodiment, the STB processor may communicate with the IPTV access network 230 via the network interface 208. In an illustrative, non-limiting embodiment, the network access customer premises equipment (CPE) 232 can facilitate communication between the network interface 208 and the IPTV access network 230. The network access CPE 232 may include a router, a local area network device, a modem, such as a digital subscriber line (DSL) modem, any other suitable device for facilitating communication between the network interface 208 of the set-top box device 202 and the IPTV access network 232, or any combination thereof.

In a particular embodiment, the memory 206 may include a user identification module 220 that is executable by the STB processor 204 to identify a current user of the set-top box device 202. In an illustrative embodiment, the current user may be identified according to a user name or other identification data. For example, the user identification module 220 can be executable by the STB processor 204 to identify the current user based on a login identification string or password. In another illustrative embodiment, the user identification module 220 can be executable by the STB processor 204 to identify the current user of the set-top box device 202 based on a security card or a smart card, biometric data, or any combination of a user identification, an authentication token, and biometric data.

In a further illustrative embodiment, user identification module 220 can be executable by the STB processor 204 to identify the current user of the set-top box device 202 based on the current user's manipulation of the remote control 216. For example, the set-top box device 202 may be associated with a number of remote controls, such as the remote control 216, where each remote control is associated with a respective user of the set-top box device 202. When a remote control, such as the remote control 216, is activated, it may send data to the set-top box device 202 that uniquely identifies the particular remote control and the user that is associated with the particular remote control.

In another illustrative embodiment, the user identification module 220 can be executable by the STB processor 204 to identify the current user of the set-top box device 202 based on television viewing during a television viewing session. In an illustrative, non-limiting embodiment, the user identification module may be executable by the STB processor 204 to access television viewing data associated with each user of the set-top box device 202 and determine the current user by comparing television viewing during the current television viewing session with previous television viewing patterns of each user of the set-top box device 202. For example, a first user of the set-top box device 202 may primarily view news programs during their respective television viewing sessions, while a second user may primarily view children's programming during their respective television viewing sessions. Continuing with this example, if the television viewing session for the current user comprises mainly children's programming, then the user identification module 220 would identify the current user as the second user.

In an illustrative, non-limiting embodiment, the user identification module 220 may be executable by the STB processor 204 to activate a channel viewing feature associated with the current user. For example, the channel viewing feature may be a parental control feature or some other television viewing restriction feature that is associated with the current user.

In a particular embodiment, the memory 206 may include a channel prediction module 222 that is executable by the STB processor 204 to determine that the set-top box device 202 is tuned to a first channel and to predict at least one next channel that a current user of the set-top box device 202 may select after the first channel. In an illustrative embodiment, the channel prediction module 222 utilizes historical data associated with the set-top box device 202 to predict the next channels. For example, the historical data may include channel selection data for each of the users associated with the set-top box device 202, a favorite channel list associated with at least one user of the set-top box device 202, demographic data associated with at least one user of the set-top box device 202, or any combination thereof. In an illustrative embodiment, the historical data may be stored in the memory 206 of the set-top box device 202. In another embodiment, the set-top box device 202 can access historical data saved at the prediction server 240.

In an illustrative, non-limiting embodiment, the channel prediction module 222 may be executable by the STB processor 204 to predict a plurality of next channels that are likely to be selected by a current user of the set-top box device 202 based on a specified number of recent channel selections by the current user. For example, the channel prediction module 222 may consider only the previous 50 channels selected by the current user when predicting the next channels that the current user will select.

In a particular embodiment, the memory 206 may include a video content request module 224 that is executable by the STB processor 204 to request video content relating to a current channel that has been selected via set-top box device 202. In addition, the video content request module is executable by the STB processor 204 to request video content related to at least one of the predicted next channels while the set-top box device 202 is tuned to the current channel.

In a particular embodiment, the memory 206 may include a video content queue module 226 that is executable by the STB processor 204 to receive video content related to the current channel and related to at least one of the predicted next channels. In an illustrative embodiment, the video content queue module 226 may be executable by the STB processor 204 to arrange video content received at the set-top box device 202 in a queue where the video content in the queue is provided in a particular order for display to the users of set-top box device 202 via the display device 212. For example, the video content queue module 226 may be executable by the STB processor 204 to arrange the video content of a plurality of predicted next channels in a queue according to a predicted sequence of next channel selections determined by the channel prediction module 222. In another illustrative, non-limiting embodiment, the video content queue module 226 may be executable by the STB processor 204 to arrange the video content of a plurality of next channels in a queue according to a predicted probability that each next channel will be selected after the current channel. For example, a next channel having a 50% probability of being selected after the current channel may be placed first in the queue and a next channel having a 25% probability of being selected after the current channel may be placed second in the queue.

In a particular embodiment, the prediction server 240 can include a prediction server processor 242. In addition, the prediction server 240 may include a user identification module 244 that is executable by the prediction server processor 242 to identify a current user of the set-top box device 202. In an illustrative embodiment, the user identification module 244 may be executable by the prediction server processor 242 to identify the current user of the set-top box device 202 based on user identification data received at the prediction server 240 from the set-top box device 202 indicating that a first user is engaged in a current television viewing session.

In another illustrative embodiment, the user identification module 244 may be executable by the prediction server processor 242 to identify the current user of the set-top box device 202 based on television viewing during a current television viewing session. For example, the prediction server 240 may receive channel selection data from the set-top box device 202 for the current television viewing session. The user identification module 244 may be executable by the prediction server processor 242 to identify the programs shown on the channels selected during the current television viewing session and compare the viewed programs to previous television viewing data from the set-top box device 202. The previous television viewing data associated with the set-top box device 202 may be arranged according to television viewing for each user of the set-top box device 202. Thus, the user identification module 244 may be executable by the prediction server processor 242 to identify the current user of the set-top box device 202 by comparing the programs viewed during the current television viewing session with viewing patterns corresponding to each user associated with the set-top box device 202.

In a particular embodiment, the prediction server may include a user behavior module 246 that is executable by the prediction server processor 242 to identify channel selections made via set-top box device 202 and to store the channel selections in association with a current user of the set-top box device 202. In an illustrative, non-limiting embodiment, the user behavior module may be executable by the prediction server processor 242 to send channel selection data and data identifying the corresponding user to a data store 254.

In a particular embodiment, the prediction server 240 may include a prediction module 248 that is executable by the prediction server processor 242 to identify a first channel to which the set-top box device 202 is tuned and to predict at least one next channel that a current user of the set-top box device 202 may select. In an illustrative embodiment, the prediction module 248 may be executable by the prediction server processor 242 to use historical data associated with the set-top box device 202 to predict the next channel(s). For example, the prediction module 248 may be executable by the prediction server processor 242 to analyze historical channel selection data associated with the current user of set-top box device 202 to determine that there is a 25% chance that the current user will switch to channel 2 from the current channel, a 10% chance that the current user will switch to channel 5 from the current channel, a 50% chance that the current user will switch to channel 10 from the current channel, and a 15% chance that the current user will switch to channel 12 from the current channel.

In an illustrative, non-limiting embodiment, the prediction module 248 may be executable by the prediction server processor 242 to predict that the set-top box device 202 will be tuned to a plurality of additional channels in addition to the plurality of next channels. For example, the predicted next channels may be three of five sports channels. The prediction module 248 may be executable by the prediction server processor 240 to utilize a favorites list associated with the current user or demographic data associated with the current user to predict that the user may switch to one or more additional channels, such as the other two of the five sports channels.

In a particular embodiment, the prediction module 248 may be executable by the prediction server processor 242 to determine how many next channels to predict based at least partially on available resources of a video distribution network, such as the IPTV access network 230. In an illustrative non-limiting embodiment, the prediction module 248 may be executable by the prediction serve processor 242 to determine how many next channels to predict based on a video content resolution associated with each of the number of next channels.

In a particular embodiment, the prediction server 240 may include a system resource module 250 that is executable by the prediction server processor 242 to evaluate the available resources of a video distribution network providing video content to the set-top box device 202 and to determine the number of channels that can be streamed to the set-top box device 202 based on the available resources of the video distribution network. The available resources of the video distribution network may include a bandwidth of at least a portion of a communication path between a video content source and the set-top box device 202, a memory usage at the set-top box device 202, data load at network access CPE 232, or any combination thereof. In an illustrative embodiment, the system resource module 250 may determine that the available resources of the video distribution network can accommodate streaming three next channels to the set-top box device 202, as well as, the channel currently tuned at the set-top box device 202. In an illustrative, non-limiting embodiment, the system resource module 250 may send data to the prediction module 248 indicating that three next channels can be accommodated by the video distribution network. The prediction module 248 may predict three channels that the current user is likely to select, such as the three channels with the highest probability of being selected by the current user based on historical data.

In another illustrative embodiment, if fewer resources become available on the video distribution network, the system resource module 250 may be executable by the prediction server processor 242 to determine that fewer next channels may be streamed to the set-top box device 202. On the other hand, if more resources become available on the video distribution network, the system resource module 250 may be executable by the prediction server processor 242 to determine that one or more additional channels may be streamed to the set-top box device 202.

In a particular embodiment, the prediction server 240 may include a video content module 252 that is executable by the prediction server processor 242 to send a request or instruction to a video server or other device to send video content of predicted next channels, the predicted additional channels, or any combination thereof, to the set-top box device 202. For example, if the prediction server 240 determines that the current user is most likely to switch from the current channel to channels 2, 4, or 6, the video content module 252 can be executable by the video prediction server 242 to send a request to a video content source to stream video content related to channels 2, 4, and 6 to the set-top box device 202.

In an illustrative, non-limiting embodiment, the video content module 252 may be executable by the prediction server processor 242 to send a request to a video content source to stream video content of a predicted next channel to the set-top box device 202 in a low resolution mode. Additionally, the video content module 252 may be executable by the prediction server processor 242 to send a request to a video content source to stream video content of the predicted next channel in a high resolution mode after the predicted next channel has been selected by the current user of set-top box device 202.

In a particular embodiment, the video content module 252 may be executable by the prediction server 242 to locate a source for the video content streamed to the set-top box device 202. In an illustrative video content module 252 may be executable by the prediction server 242 to send a request to each video content source in a multicast video distribution network for data indicating whether or not the respective video content source includes a forwarding state for video content related to at least one of the predicted next channels. Video content sources may include a video head-end office, a regional head-end office, a central office, a router associated with the video distribution network, such as a router associated with IPTV access network 230, other set-top box devices, or any combination thereof.

In an illustrative embodiment, the video content module 252 may be executable by the prediction server processor 242 to locate at least one video content source that is physically closest to the set-top box device 202. In an illustrative, non-limiting embodiment, the physically closest video content source for the video content of at least one of the predicted next channels could be customer premises equipment in the same neighborhood as the set-top box device 202, a device, such as a router, associated with a central office in the same city as the set-top box device 202, or a device, such as a router, associated with a regional head-end office in the same state as the set-top box device 202.

In an illustrative embodiment, the video content module 252 may be executable by the prediction server processor 242 to instruct the at least one closest source to stream video content to the set-top box device 202. In an illustrative, non-limiting embodiment, the video content module 252 may be executable by the prediction server processor 242 to send instructions to devices along the video distribution network between the physically closest video content source and the set-top box device 202 to establish forwarding states for the video content streaming from the physically closest video content source to the set-top box device 202.

In a particular embodiment, the prediction server may be coupled to a data store 254. In an illustrative embodiment, the data store 254 may include historical data associated with each user of set-top box device 202. The historical data may include channel selection data, a favorite channel list associated with at least one user of the set-top box device, demographic data associated with at least one user of the set-top box device, or any combination thereof.

In an illustrative embodiment, the data store 254 may arrange channel selection data received from user behavior module 246 according to the respective user associated with corresponding channel selections. In an illustrative, non-limiting embodiment, the channel selection data may be arranged according to a time of day when a particular channel is selected via the set-top box device 202. In another illustrative, non-limiting embodiment, the channel selection data for each user of the set-top box device 202 may include one or more weighting factors that are applied to channel selections made by each user of the set-top box device 202 within a pre-defined time period.

For ease of explanation, the various modules 220-226 and 244-252 have been described in terms of processor-executable instructions. However, those skilled in the art will appreciate that such modules can be implemented as hardware logic, processor-executable instructions, or any combination thereof.

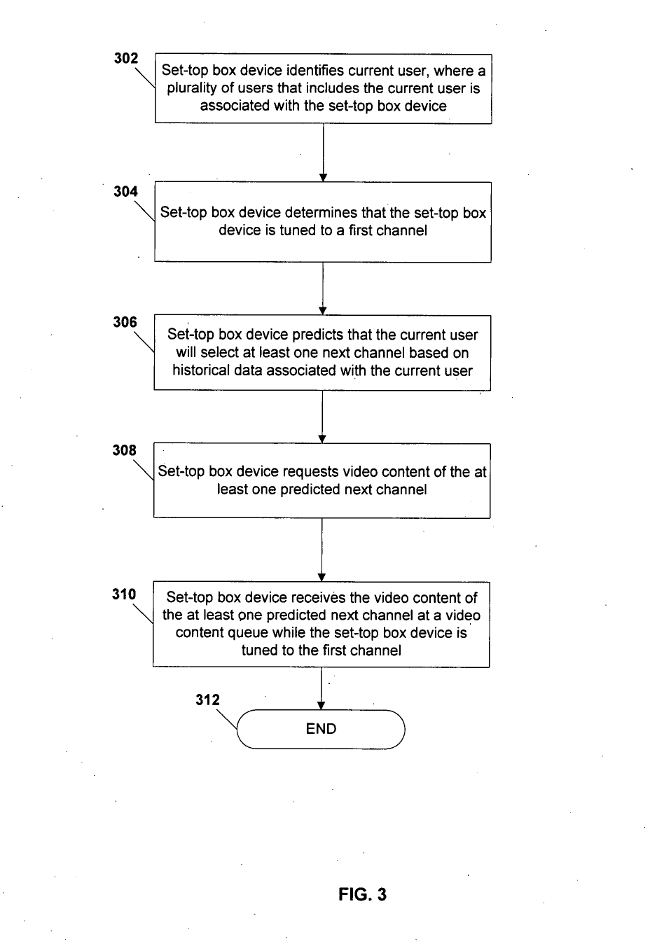

FIG. 3 is a flow diagram of a particular illustrative embodiment of a method of providing video content. At block 302, the current user of a set-top box device is identified. The current user may be one of a plurality of users that are associated with the set-top box device. Moving to block 304, a determination is made that the set-top box device is tuned to a first channel.

Proceeding to block 306, at least one next channel that a current user will select after the current channel is predicted at the set-top box device. The prediction may be made based on historical data associated with the current user. At block 308, video content related to the at least one next channel is requested by the set-top box device.

Moving to block 310, the video content related to the at least one next channel is received at the set-top box device via a video distribution network. The video content may be received in a video content queue of the set-top box device while the set-top box device is tuned to the first channel. The method terminates at 312.

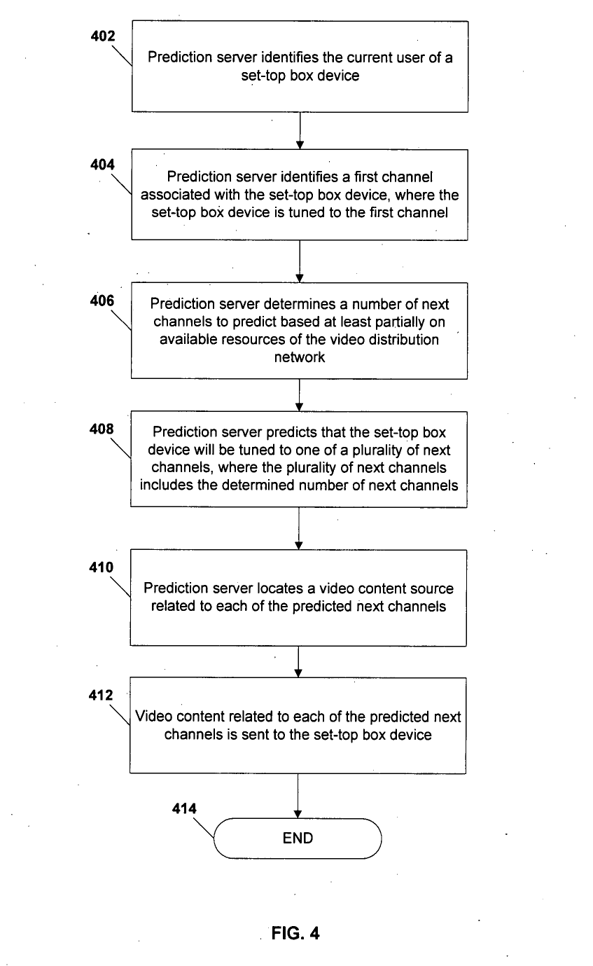

FIG. 4 is a flow diagram of a second particular illustrative embodiment of a method of providing video content. At block 402, the current user of a set-top box device is identified by a prediction server communicating with the set-top box device via a video distribution network. Moving to block 404, the prediction server identifies a first channel associated with the set-top box device, where the set-top box device is currently tuned to the first channel.

Proceeding to block 406, the prediction server determines a number of next channels to predict based at least partially on available resources of the video distribution network. At block 408, the prediction server predicts a plurality of next channels to which the set-top box device is likely to be tuned. The plurality of predicted next channels includes the determined number of next channels.

Moving to block 410, in a particular embodiment, a video content source of the video distribution network is located for the video content related to each of the predicted next channels. Proceeding to block 412, video content related to each of the predicted next channels is sent to the set-top box device. The method terminates at 414.

FIG. 5 is a diagram of an arrangement of data in a system of providing video content. The data arrangement 500 may include probability related to a channel 1, a channel 2, a channel 3, a channel 4, and any number of other channels that may have video content accessible to a respective user of a particular set-top box device. The data arrangement may be organized based on the probability that the respective user will change from a current channel to a next channel. For example, the probabilities associated with the respective user changing from channel 1 to another channel are placed in row 502. Similarly, the probabilities associated with changing from channels 2, 3, and 4 to another channel are placed in rows 504, 506, and 508, respectively. The next channels that the respective user may switch to from each of channels 1, 2, 3, and 4 are arranged in rows 510, 512, 514, and 516, respectively. For example, there is a 20% probability that the respective user of the particular set-top box device will change from channel 1 to channel 2, a 30% probability that the respective user will change from channel 1 to channel 3, and a 10% probability that the respective user will change from channel 1 to channel 4. There is a 40% probability that the respective user may change from channel 1 to a number of additional channels that may be selected via the particular set-top box device, but these specific channels are not shown in FIG. 5.

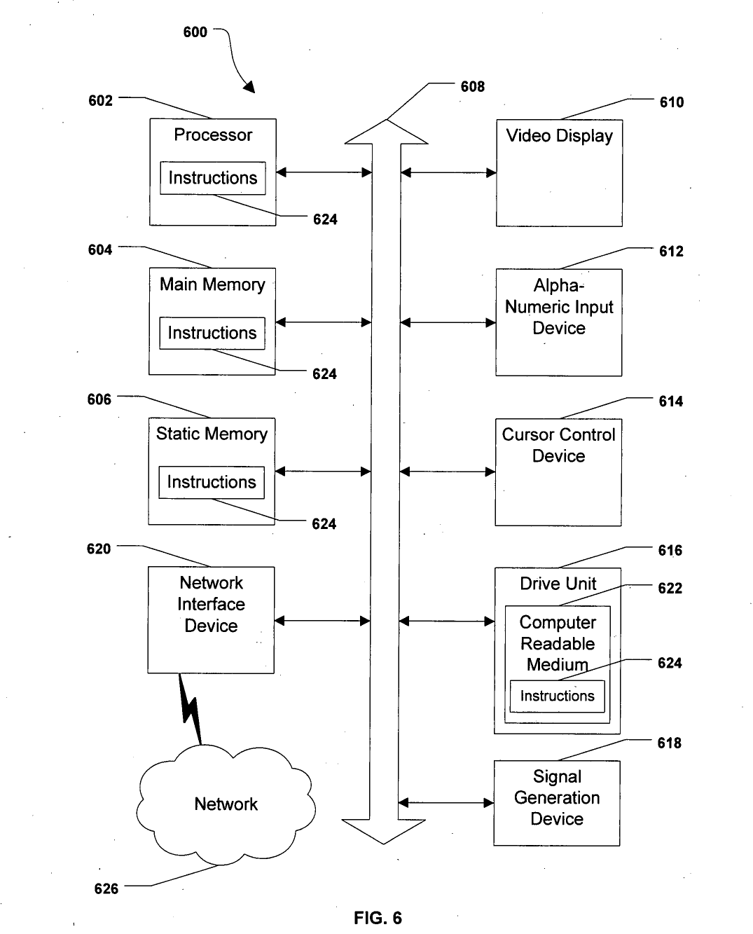

Referring to FIG. 6, an illustrative embodiment of a general computer system is shown and is designated 600. The computer system 600 can include a set of instructions that can be executed to cause the computer system 600 to perform any one or more of the methods or computer based functions disclosed herein. The computer system 600, or any portion thereof, may operate as a standalone device or may be connected, e.g., using a network, to other computer systems or peripheral devices, including a server or set-top box device, as shown in FIGS. 1-2.

In a networked deployment, the computer system may operate in the capacity of an IPTV server, such as a prediction server, or a set-top box device. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics-processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620.

In a particular embodiment, as depicted in FIG. 6, the disk drive unit 816 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37° C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing video content, the method comprising:
identifying a current user of a set-top box device, wherein a plurality of users that includes the current user is associated with the set-top box device;
identifying a first channel associated with the set-top box device, wherein the set-top box device is tuned to the first channel; and
predicting that the current user is likely to select at least one next channel based on historical data associated with the current user;
wherein video content of the at least one next channel is sent to the set-top box device via a video distribution network while the set-top box device is tuned to the first channel.

2. The method of claim 1, further comprising predicting that the current user will select one of a plurality of next channels, wherein video content of each of the plurality of next channels is streamed to the set-top box device while the set-top box device is tuned to the first channel.

3. The method of claim 2, further comprising determining a number of next channels based at least partially on available resources of the video distribution network, wherein the plurality of next channels includes the determined number of next channels.

4. The method of claim 2, further comprising determining a probability related to each of the plurality of next channels, wherein video content of each of the plurality of next channels is queued at the set-top box device in order of probability.

5. The method of claim 2, further comprising predicting that the current user will select each of the plurality of next channels in a predicted sequence, wherein video content of each of the plurality of next channels is queued at the set-top box device in order of the predicted sequence.

6. The method of claim 1, wherein the current user is identified based on a user identification, authentication token, or any combination thereof, received at the set-top box device.

7. The method of claim 1, wherein the current user is identified based on television viewing during a current television viewing session.

8. The method of claim 1, wherein different historical data is associated with each of the plurality of users associated with the set-top box device.

9. A method of providing video content, the method comprising:
identifying a first channel associated with a set-top box device, wherein the set-top box device is tuned to the first channel;
determining a number of next channels to predict based at least partially on available resources of a video distribution network; and
predicting, based on historical data associated with the set-top box device, that the set-top box device will be tuned to one of a plurality of next channels, wherein the plurality of next channels includes the determined number of next channels;
wherein video content of each of the plurality of next channels is streamed to the set-top box device while the set-top box device is tuned to the first channel.

10. The method of claim 9, wherein the number of next channels to predict is determined based on a video content resolution associated with each of the number of next channels.

11. The method of claim 9, wherein the available resources of the video distribution network include a bandwidth of at least a portion of a communication path between a video content source and the set-top box device, a memory usage at the set-top box device, data load at customer premise equipment (CPE) coupled to the set-top box device, or any combination thereof.

12. The method of claim 9, further comprising receiving user identification data from the set-top box device indicating that a first user is engaged in a current television viewing session.

13. The method of claim 12, wherein the historical data includes data related to channel selections associated with the first user and wherein one or more weighting factors are applied to channel selections made by the first user within a pre-defined time period.

14. A system to provide video content, the system comprising:
a processor and a memory accessible to the processor, wherein the memory includes:
a user identification module executable by the processor to identify a current user of a set-top box device, wherein a plurality of users that includes the current user is associated with the set-top box device;
a user behavior module executable by the processor to identify a first channel associated with the set-top box device, wherein the set-top box device is tuned to the first channel;
a prediction module executable by the processor to predict that the current user will, select a next channel based on historical data associated with the current user; and
a video content module executable by the processor to instruct a video source to send video content of the next channel to the set-top box device via a video distribution network while the set-top box device is tuned to the first channel.

15. The system of claim 14, wherein the video content of the next channel is sent to the set-top box device in a low resolution while the set-top box device is tuned to the first channel.

16. The system of claim 15, wherein video content of the next channel to the set-top box device is sent to the set-top box device in a high resolution after the next channel is selected by the current user.

17. The system of claim 14, wherein the prediction module is executable by the processor to predict, based on historical data associated with the set-top box device, that the set-top box device will be tuned to a plurality of additional channels, wherein the plurality of additional channels are in addition to the plurality of next channels.

18. The system of claim 17, wherein the video content module is executable by the processor to locate at least one video content source associated with the plurality of additional channels.

19. The system of claim 18, wherein the at least one video content source includes at least one physically closest source and wherein the video content module is executable by the processor to instruct the at least one closest source to stream video content of the plurality of additional channels from the at least one closest source to the set-top box device.

20. The system of claim 14, further comprising a data storage device accessible to the processor, wherein the data storage device includes the historical data associated with the plurality of users.

21. The system of claim 14, wherein the historical data associated with the current user includes at least channel selection data for the current user and wherein the prediction module is executable by the processor to predict the next channel based on a specified number of recent channel selections by the current user.

22. A set-top box device, comprising:
a processor and a memory accessible to the processor, wherein the memory includes:
a user identification module executable by the processor to identify a current user of a set-top box device, wherein a plurality of users that includes the current user is associated with the set-top box device;
a channel prediction module executable by the processor to determine that the set-top box device is tuned to a first channel and to predict that the current user will select a next channel based on historical data associated with the current user; and
a video content request module executable by the processor to request video content of the next channel, wherein the set-top box device receives the video content of the next channel while the set-top box device is tuned to the first channel.

23. The set-top box device of claim 22, wherein the memory includes a data storage device to store historical data associated with the plurality of users.

24. The set-top box device of claim 22 wherein the current user is identified based on channel selections made in a current television viewing session.

25. The set-top box device of claim 24, wherein the user identification module is executable by the processor to activate a channel viewing feature associated with the current user.

26. The set-top box device of claim 25, wherein the channel viewing feature is a parental control feature.

27. A computer-readable medium having instructions to cause a processor to execute a method comprising:
identifying a first channel associated with a set-top box device, wherein the set-top box device is tuned to the first channel;
determining a number of next channels to predict based at least partially on available resources of a video distribution network; and
predicting, based on historical data associated with the set-top box device, that the set-top box device will be tuned to one of a plurality of next channels, wherein the plurality of next channels includes the determined number of next channels;
wherein video content of each of the plurality of next channels is streamed to the set-top box device while the set-top box device is tuned to the first channel.

28. The computer-readable medium of claim 27, wherein the historical data includes channel selection data, a favorite channel list associated with at least one user of the set-top box device, demographic data associated with at least one user of the set-top box device, or any combination thereof.

29. The computer-readable medium of claim 28, wherein the channel selection data is arranged according to a time of day when a particular channel is selected via the set-top box device.

30. The computer-readable medium of claim 29 having instructions for causing a processor to execute a method comprising predicting that the set-top box device will be tuned to one of a plurality of next channels according to a first set of channel selection data during a first time period and according to a second set of channel selection data during a second time period.
